(19) United States
(12) Patent Application Publication
(10) Pub. No.: US 2002/0120586 A1
(43) Pub. Date: Aug. 29, 2002

(54) Copyrighted work managing method and apparatus thereof

(76) Inventors: Teruo Masaki, Chiba (JP); Masaya Otsuka, Tokyo (JP)

Correspondence Address: JAY H. MAIOLI, Cooper & Dunham LLP, 1185 Avenue of the Americas, New York, NY, 10036, US

(21) Appl. No.: 10/033,206

(22) Filed: Dec. 28, 2001

(30) Foreign Application Priority Data
Jan. 5, 2001 (JP) P2001-000686

(51) Int. Cl. G06F 17/60

(52) U.S. Cl. 705/75; 705/1

(57) ABSTRACT

A copyrighted work managing method for managing copyrighted work data transmitted on a communication network is disclosed, that comprises the steps of (a) detecting copyrighted work data from communication data transmitted from a client on the communication network, (b) determining whether or not the user has performed a copyright licensing process for the copyrighted work data detected at the detecting step (a) against a copyright owner of the copyrighted work data, and (c) prohibiting the communication data from being transmitted corresponding to the determined result at the determining step (b).

### BACKGROUND OF THE INVENTION

1. Field of the Invention

The present invention relates to a copyrighted work managing method and an apparatus thereof for preventing a copyrighted work from being illegally uploaded from an open communication network such as the Internet.

2. Description of the Related Art

In recent years, communication networks such as the Internet of which information devices such as computers are becoming common at explosive pace. In particular, the Internet covers most of the world. A very large number of servers are connected to the Internet. A very large number of users are always accessing the Internet. Nowadays, it is almost impossible to know not only all servers connected to the Internet, but all users who are accessing the Internet.

On the Internet, information is transmitted through servers that function as nodes. As a method for accessing the Internet, the user should directly connect his or her server to the Internet. Alternatively, the user should contract with a so-called provider for an Internet connection service and then connect user's terminal unit to a server of the provider using a dial-up connecting method.

In addition, on the Internet, the user can upload data to a server for which he or she has contracted so as to publish information. As a means for publishing information to the Internet, web pages are known. Using web pages, Internet addresses from which data is published (these addresses are referred to as URL: Uniform Resource Locator) can be easily accessed. In addition, using for example FTP (File Transfer Protocol), directories that store data can be directly accessed.

As was described above, since it is very difficult to know all servers and users of the Internet, illegal actions cannot be prevented. For example, an illegal action of which an unauthorized person publishes a copyrighted work that belongs to another person is openly performed without permission of the copyright owner. For example, when a user uploads a copyrighted work that belong to another person to a server and publishes the copyrighted work on a web page, many unspecified people can freely obtain the copyrighted work. In this case, the copyright of the copyright owner is infringed. As a result, the copyright owner will lose the benefit that he or she ought to obtain from the copyrighted work.

Conventionally, the copyright owner may notify the server supervisor of such an illegal action. Alternatively, the copyright owner may hack the server that performs such an illegal action through the network. Alternatively, the copyright owner may directly attack a program of a user who performs such an illegal action. Conventionally, in such a manner, a service that performs an illegal action is prohibited from being provided or used.

Even if such a hacking to a server that performs an illegal action, an attacking to a user who uses an illegal action, or a notification to a server supervisor is used, since a very large number of users are always accessing a large number of servers connected to the Internet, the problem about such an illegal action cannot be thoroughly solved.

### OBJECTS AND SUMMARY OF THE INVENTION

Thus, an object of the present invention is to provide a copyrighted work managing method and an apparatus thereof that allow a copyrighted work to be prevented from being illegally uploaded to a server on a network such as the Internet.

A first aspect of the present invention is a copyrighted work managing method for managing copyrighted work data transmitted on a communication network, comprising the steps of (a) detecting copyrighted work data from communication data transmitted by a user on the communication network, (b) determining whether or not the user has performed a copyright licensing process for the copyrighted work data detected at the detecting step (a) against a copyright owner of the copyrighted work data, and (c) prohibiting the communication data from being transmitted corresponding to the determined result at the determining step (b).

A second aspect of the present invention is a copyrighted work managing apparatus for managing copyrighted work data transmitted on a communication network, comprising a detecting means for detecting copyrighted work data from communication data transmitted by a user on the communication network, a determining means for determining whether or not the user has performed a copyright licensing process for the copyrighted work data detected by said detecting means against a copyright owner of the copyrighted work data, and a transmission prohibiting means for prohibiting the communication data from being transmitted corresponding to the determined result of said determining means.

A third aspect of the present invention is a copyrighted work managing method for managing copyrighted work data transmitted on a communication network, comprising the steps of (a) detecting copyrighted work data from communication data transmitted by a user on the communication network, (b) determining whether or not the user has performed a copyright licensing process for the copyrighted work data detected at the detecting step (a) against a copyright owner of the copyrighted work data, and (c) notifying the user that he or she has not performed the copyright licensing process corresponding to the determined result at the determining step (b).

A fourth aspect of the present invention is a copyrighted work managing apparatus for managing copyrighted work data transmitted on a communication network, comprising a detecting means for detecting copyrighted work data from communication data transmitted by a user on the communication network, a determining means for determining whether or not the user has performed a copyright licensing process for the copyrighted work data detected by said detecting means against a copyright owner of the copyrighted work data, and a notifying means for notifying the user that he or she has not performed the copyright licensing process corresponding to the determined result of said determining means.

A fifth aspect of the present invention is a copyrighted work managing method for managing copyrighted work data transmitted on a communication network, comprising the steps of (a) detecting copyrighted work data from communication data transmitted by a user on the communication network, (b) determining whether or not the user has performed a copyright licensing process for the copyrighted work data detected at the detecting step (a) against a copyright owner of the copyrighted work data, and (c) destroying the communication data corresponding to the determined result at the determining step (b).

A sixth aspect of the present invention is a copyrighted work managing apparatus for managing copyrighted work data transmitted on a communication network, comprising a detecting means for detecting copyrighted work data from communication data transmitted by a user on the communication network, a determining means for determining whether or not the user has performed a copyright licensing process for the copyrighted work data detected by said detecting means against a copyright owner of the copyrighted work data, and a destroying means for destroying the communication data corresponding to the determined result of said determining means.

As was described above, according to the present invention, copyrighted work data is detected from communication data transmitted to a communication network by a user. It is determined whether or not the user has performed a copyright licensing process for the detected copyrighted work data against the copyright owner. Corresponding to the determined result, the communication data is prohibited from being transmitted. Thus, copyrighted work data for which the user has not performed the copyright licensing process against the copyright owner can be prevented from being transmitted to the network.

In addition, according to the present invention, copyrighted work data is detected from communication data transmitted to a communication network by a user. It is determined whether or not the user has performed a copyright licensing process for the detected copyrighted work data against the copyright owner. Corresponding to the determined result, the user is notified that he or she has not performed the copyright licensing process. Thus, the user is promoted for the copyright licensing process for copyrighted work data that belongs to another person.

In addition, according to the present invention, copyrighted work data is detected from communication data that is transmitted to a communication network by a user. It is determined whether or not the user has performed a copyright licensing process for the detected copyrighted work data against the copyright owner. Corresponding to the determined result, the communication data is destroyed. Thus, even if the user transmits copyrighted work data for which he or she has not performed the copyright licensing process against the copyright owner to the network, he or she cannot accomplish his or her purpose.

These and other objects, features and advantages of the present invention will become more apparent in light of the following detailed description of a best mode embodiment thereof, as illustrated in the accompanying drawings.

### BRIEF DESCRIPTION OF THE DRAWINGS

FIG. 1 is a schematic diagram showing an example of a system according to a first embodiment of the present invention;

FIG. 2 is a flow chart showing an example of a copyrighted work data transferring process according to the first embodiment of the present invention;

FIG. 3 is a block diagram showing the structure of an example of a gateway according to the first embodiment of the present invention;

FIG. 4 is a schematic diagram showing the structure of an example of music data;

FIG. 5 is a schematic diagram showing the relation between a determined result and an action to be performed corresponding to music data detected from communication data and a transmission source thereof; and

FIG. 6 is a block diagram showing the structure of an example of a server according to a second embodiment of the present invention.

### DETAILED DESCRIPTION OF THE PREFERRED EMBODIMENTS

(First Embodiment)

Next, a first embodiment of the present invention will be described. According to the present invention, when a user connected to a network tries to transmit copyrighted work data that belongs to another person to a server on the network, it is determined whether or not he or she has obtained a license from the copyright owner. When the determined result represents that the use has not obtained the license from the copyright owner, he or she is notified of a warning. In addition, the copyright owner is also notified that the user tried to transmit the copyrighted work data. As a result, the user who tried to transmit a copyrighted work that does not belong thereto to the network is required that he or she is prompted for performing a copyright licensing process for the copyrighted work against the copyright owner. In addition, corresponding to the determined result, it is possible to prohibit copyrighted work data that the user has not performed the copyright licensing process against the copyright owner from being transmitted.

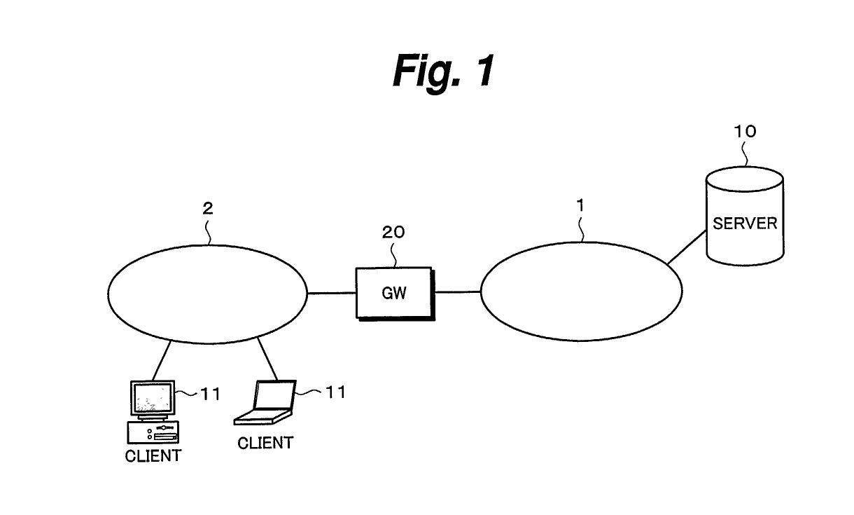

FIG. 1 shows an outlined structure of an example of a system according to the first embodiment of the present invention. Referring to FIG. 1, a network 1 to which a server 10 is connected and a network 2 to which information devices 11, 11, . . . and so forth that are users' personal computers are connected are communicatively connected through a gateway 20 composed of for example a computer system each other. As a whole, one network is structured. The network composed of the network 1, the network 2, the gateway 20, and so forth is for example the Internet. The present invention is applied for the server 10 and/or the gateway 20.

The network 1 is composed of for example LAN (Local Area Network) or WAN (Wide Area Network). The server 10 is connected to the network 1. In FIG. 1, 10 one server 10 is connected to the network 1. It should be noted that a plurality of servers 10, 10, . . . , and so forth may be connected to the network 1. The network 2 is a network connected using LAN, WAN, or PPP (Point-to-Point Protocol). Information devices (client) 11, 11, . . . , and so forth such as users' personal computers are connected to the network 2. The information devices 11, 11, . . . , and so forth are directly connected to the Internet. Alternatively, the information devices 11, 11, . . . , and so forth are connected to the network 2 through a provider (not shown) that provides a service for connecting them to the network 2.

When the network structure shown in FIG. 1 is the Internet, the information devices 11, 11, . . . , and so forth are connected to the network 2 corresponding to PPP. At that point, the information devices 11, 11, . . . , and so forth connected to the network 2 are assigned unique IP (Internet Protocol) addresses by the provider. When information is transmitted from a particular information device 11 to the network 1 using electronic mail or the like, the network 1 and the network 2 can identify the information device 11 as the transmission source corresponding to the assigned IP address.

At the time the present invention was made, the IP is based on version IPv4. Thus, the information device 11 is assigned an IP address that differs in each connection session. However, in the IP version IPv6 that is currently being prepared, since the address space of IP addresses is substantially indefinite, it will become possible to fixedly assign unique IP addresses to the information devices 11, 11, . . . , and so forth.

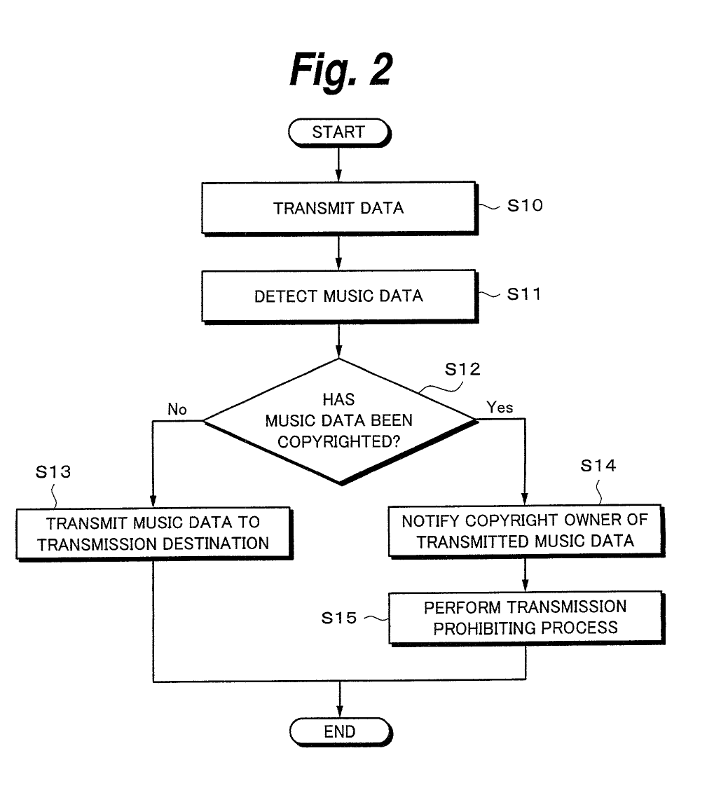

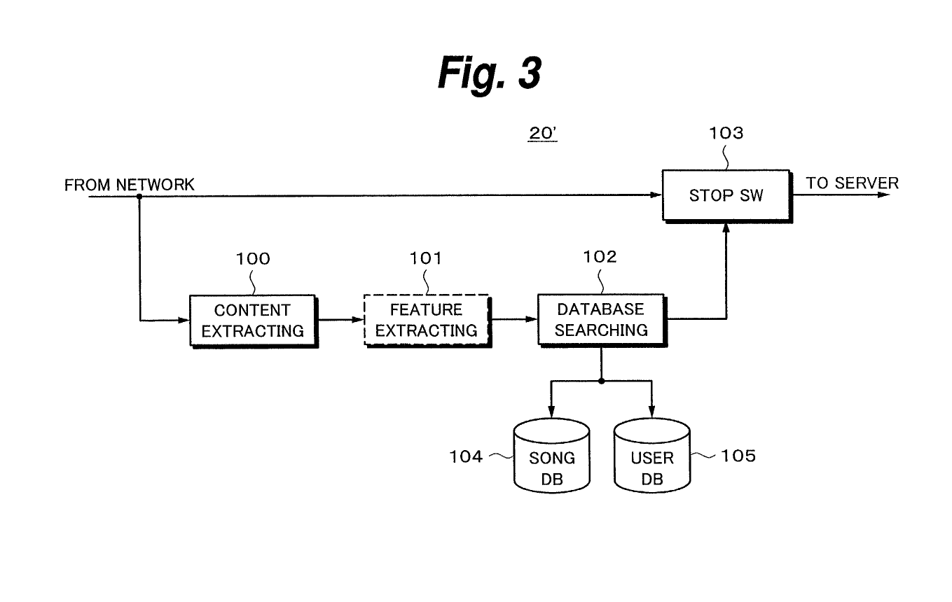

Next, with reference to FIGS. 2 and 3, the case that a particular user transmits copyrighted work data from the information device 11 to the network 2 and transfers the copyrighted work data to the server 10 will be described. In the following description, it is assumed that the copyrighted work data is music data of which a song is reproduced. In addition, it is assumed that for example the music data is recorded on a CD (Compact Disc) and sold therewith and that the copyright thereof has been already registered. Thus, the copyright owner of the copyrighted work data can request a user who uses the copyrighted work for the royalty.

FIG. 2 is a flow chart showing an example of a copyrighted work data transferring process according to the first embodiment of the present invention. FIG. 3 shows the structure of an example of the gateway 20 according to the first embodiment of the present invention. For simplicity, FIG. 3 shows only a portion that detects a content and prohibits data from being transmitted. Communication data transmitted from the network 1 to the network 2 is temporarily stored to the gateway 20. Thereafter, the communication data is supplied to a stop SW portion 103 and a content extracting portion 100. In addition, the gateway 20 has a song database 104 and a user database 105. The song database 104 is used to search for music data (for example, music data recorded on for example CDs) whose copyright has been registered in a predetermined manner. The user database 105 stores user copyright information with respect to music data registered to the song database 104.

The user converts the format of music data recorded on a CD that belong to him or her into the format of which the music data is read by the information device 11. When necessary, the converted music data is compression encoded in a predetermined format. At step S10, the converted music data is transmitted as communication data to the network 1 by the information device 11.

Music data is transmitted as an attached file of electronic mail using for example SMTP (Simple Mail Transfer Protocol). Alternatively, music data may be directly transmitted to a directory designated as an upload place of the server 10 using for example FTP (File Transfer Protocol). Alternatively, music data may be transmitted using HTTP (Hyper Text Transfer Protocol).

Communication data that is transmitted from the network 2 to the network 1 is temporarily supplied to the gateway 20. Thereafter, the data is supplied to the stop SW portion 103 and the content extracting portion 100. At step S11, the content extracting portion 100 extracts a content (in this example, music data) from the supplied communication data. For example, when the communication data is transmitted using an attached file of electronic mail or FTP, it is determined whether or not the data is music data corresponding to header information or an extension of the transmitted file. The present invention is not limited to such a music data (content) detecting method. For example, it may be determined whether communication data is music data depending on whether it has a particular pattern.

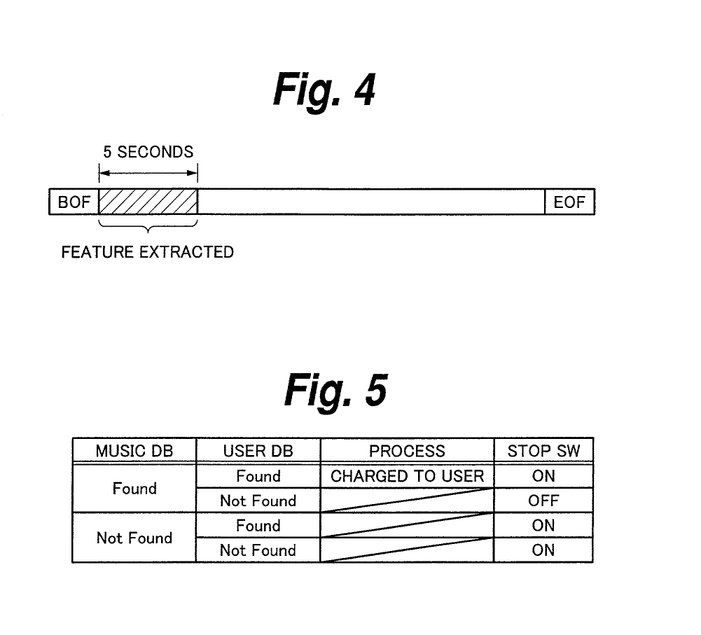

Music data that is extracted from the communication data by the content extracting portion 100 is supplied to a feature extracting portion 101. The feature extracting portion 101 extracts a feature portion from the supplied music data. For example, a method of which the beginning portion of data is extracted for several seconds and the feature of the data is extracted corresponding to the frequency characteristic of the music data for several seconds has been already proposed. Assuming that music data has a structure as shown in FIG. 4, the frequency characteristic is obtained for five seconds after BOF (Begin Of File) using for example FFT (Fast Fourier Transform). Corresponding to the obtained frequency characteristic, the feature of the data is extracted.

The feature extracting portion 101 can extract a feature from music data even if it has been compression encoded using a predetermined compression encoding process for example MP3 (MPEG1 Audio Layer 3). For example, music data that has been compression encoded is decompressed. The beginning portion is extracted as a feature from the decompressed music data for several seconds. Alternatively, corresponding to a parameter of a compression encoding process, a feature may be extracted.

At step S12, corresponding to the feature of the music data extracted by the feature extracting portion 101, a database (DB) searching portion 102 searches the song database 104 and the user database 105. In the song database 104, music data, a feature extracted therefrom, and attribute information of the music data are correlated and stored. The attribute information of music data is composed of information of for example song name, performer, composer, arranger, and lyric writer of a song, information of a CD that contains the song, and so forth.

When a header that describes attribute information of music data is added to music data contained in communication data, information of the header portion can be extracted from the music data. Thus, the feature extracting portion 101 and the process thereof can be omitted. In this case, the song database 104 is searched for the extracted header information. When attribute information of music data is embedded as a watermark to the music data, the water mark is detected by the feature extracting portion 101. The attribute information embedded as the water mark is extracted and the song database 104 is searched for the extracted attribute information.

As the searched result of the song database 104, it is determined whether or not the music data has been copyrighted in a predetermined manner. When the determined result represents that the music data has not been copyrighted, the flow advances to step S13. At step S13, the stop SW portion 103 allows the supplied communication data to be transmitted from the gateway 20 to the network 1. The communication data is transmitted from the gateway 20 to the network 1. As a result, the communication data is received by the server 10 as the transmission destination.

In contrast, when the determined result of the song database 104 represents that the music data contained in the transmitted communication data has been copyrighted, the database searching portion 102 searches the user database 105 for user's information with respect to the copyright licensing process corresponding to the music data stored in the song database 104. The copyright licensing process is performed when the user pays a predetermined amount of money for copyrighted music data to the copyright owner. When the determined result represents that the user has performed the predetermined copyright licensing process for the music data corresponding to the searched result of the user database 105, the flow advances to step S13. At step S13, the transmission of the communication data to the server 10 is permitted.

In contrast, when the determined result at step S12 represents that the music data contained in the communication data has been copyrighted and when the user who has transmitted the communication data has not performed the predetermined copyright licensing process for the music data, the flow advances to step S14. At step S14, the copyright owner of the music data is notified that the copyrighted music data is tried to be illegally transmitted to the server 10.

At step S15, corresponding to the searched result of the database searching portion 102, the stop SW portion 103 prohibits the supplied communication data from being transmitted from the gateway 20 to the network 2. It is possible to substitute the order of step S14 and step S15.

The transmission prohibiting process for communication data may be performed when the communication data is transferred from the network 1 to the network 2, not when the communication data is transferred from the network 2 to the network 1.

In addition, according to the present invention, the method for prohibiting communication data from being transmitted is not limited when the data is transferred. For example, when a communication data transfer request is transmitted from the information device 11, the transfer request may be rejected. In addition, the transmission source of the communication data may be notified that the transmission request was rejected.

In addition, the process performed at step S15 is not limited to the process for prohibiting communication data from being transmitted. For example, communication data to be transmitted may be destroyed so that it cannot be used for a desired purpose. Communication data may be destroyed in various manners. For example, a substantial portion of communication data may be broken. Alternatively, bits or bytes of communication data may be randomly rearranged. Alternatively, while a header portion of communication data is left, the other portions may be deleted. Alternatively, the entire file of communication data may be deleted. Alternatively, communication data may be substituted with another file with a predetermined content. Such destroyed communication data may be transmitted to the network 2. The communication data destroying process may be performed by the stop SW portion 103.

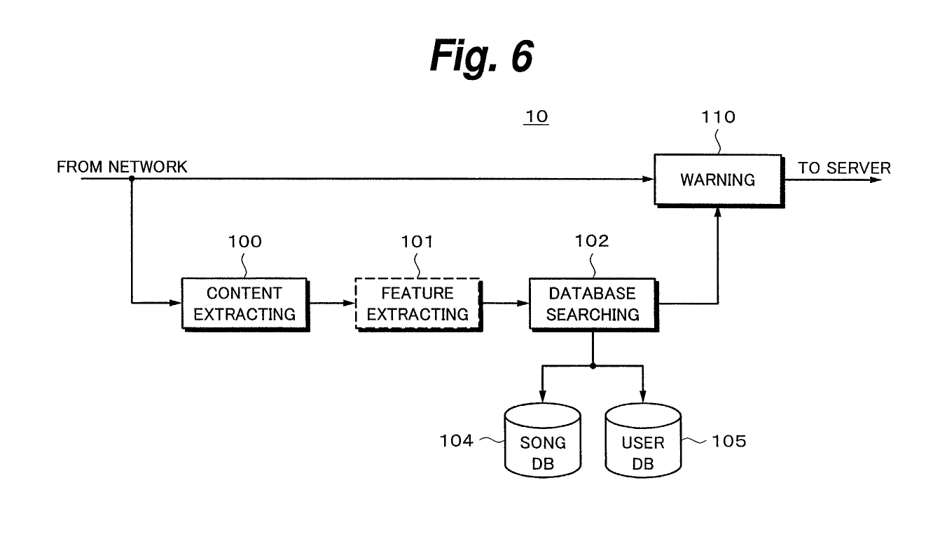

FIG. 5 shows the relation between the determined result at step S12 and a process performed corresponding thereto. When information that matches music data contained in communication data received by the gateway 20 has been registered to the song database 104 (found) and when the user who has transmitted the communication data has been registered to the user database 105 (found), a predetermined copyright licensing process is performed for the user (for example, a charging process is performed for the user). In addition, the stop SW portion 103 is turned on, allowing the communication data to be transmitted to the server 10. When the song database 104 is “found” and when the user who has transmitted the communication data has not been registered to the user database 105 (not found), the copyright licensing process is not performed for the user. In addition, the stop SW portion 103 is turned “off”, prohibiting the communication data from being transmitted to the server 10.

On the other hand, when information that matches music data contained in communication data received by the gateway 20 has not been registered to the song database 104 (not found), regardless of whether or not the user who has transmitted the communication data has been registered to the user database 105, the copyright licensing process is not performed for the user. In addition, the stop SW portion 103 is turned “on”, allowing the communication data to be transmitted to the server 10.

Next, a second embodiment of the present invention will be described. Unlike with the first embodiment, according to the second embodiment, the process performed by the gateway 20 is performed by the server 10. FIG. 6 shows the structure of an example of the server 10 according to the second embodiment of the present invention. The structure shown in FIG. 6 may be a proxy server against the server 10. The server 10 shown in FIG. 6 may be applied for the system shown in FIG. 1. For simplicity, FIG. 6 shows only a portion that detects a content. In addition, in FIG. 6, similar portions to those in FIG. 3 will be denoted by similar reference numerals and their description will be omitted.

In the structure shown in FIG. 6, the stop SW portion 103 shown in FIG. 3 is substituted with a warning portion 110. Communication data is transmitted from an information device 11 of a particular user to the server 10. At first, the communication data is transmitted to a network 1 and then transmitted to a network 2 through the gateway 20. Thereafter, the communication data is received by the server 10. The communication data is supplied to both the warning portion 110 and a content extracting portion 100.

When the communication data is supplied to the content extracting portion 100, as with steps S11 and S12 of the flow chart shown in FIG. 2, a copyright licensing process is performed. As a result, a searched result of a database searching portion 102 is supplied to the warning portion 110. As with step S12, when the determined result represents that the communication data contains music data, that the music data has been copyrighted, and that the user as the transmission source has not performed a predetermined copyright licensing process for the music data, the information device 11 as the transmission source of the communication data is notified of the warning that the user is prompted for performing the predetermined copyright licensing process.

The warning to the information device 11 as the transmission source is transmitted to an electronic mail address searched corresponding to the IP address of the transmission source. When the IP version is IPv6, since the information devices 11, 11, . . . , and so forth can be fixedly assigned unique IP addresses, the method according to the second embodiment can be sufficiently accomplished. Even if the IP version is IPv4, as long as the connection of the information device 11 to the network 1 is retained in the state that data is transmitted at step S10, since the IP address of the information device 11 does not change, the sever 10 can notify the information device 11 of the warning.

In the case that communication data is transferred to the server 10 using FTP, when the information device 11 is connected to the server 10, it may notify of the warning the electronic mail address to which the communication data is transmitted from the information device 11. When the information device 11 is connected to the network through ISP (Internet Service Provider), the supervisor of ISP may be notified of the warning. When data is uploaded using a web browser, the warning may be displayed on a page that represents the transferred result.

When music data that has been copyrighted is transmitted to the server 10 and when the determined result represents that the user who has transmitted the music data has not performed the predetermined copyright licensing process for the music data, the server 10 may notify the copyright owner that his or her copyright may have been infringed using for example electronic mail. Alternatively, when music data is registered to the server 10, such a process may be performed so that the music data is not registered to the server 10.

As with the first embodiment, according to the second embodiment, when the determined result represents that the user who has transmitted music data had not performed a predetermined copyright licensing process for the music data, the communication data (music data) can be destroyed.

In addition, both the structure according to the first embodiment and the structure according to the second embodiments can be accomplished. For example, the stop SW portion 103 shown in FIG. 3 is provided with the function of the warning portion 110 shown in FIG. 6. In this case, the stop SW portion 103 prohibits communication data from being transmitted to the server 10. In addition, the transmission source of the communication data is notified of the warning. Instead of prohibiting communication data from being transmitted, the communication data may be destroyed. Just after step S10, even if the information device 11 as the transmission source of the communication data is disconnected, since the music data is prohibited from being transmitted at step S15, the copyright of the communication data is protected.

When the structure shown in FIG. 6 is disposed as a proxy server for the information device 11, the same effect can be expected. When the proxy server checks for communication data and determines that there is the possibility of which the communication data infringes the copyright, the proxy server prohibits the communication data from being transmitted to the sever 10 and notifies the transmission source of the warning. In this case, instead of prohibiting communication data from being transmitted, the communication data may be destroyed.

In the above example, the warning portion 110 notifies a user who may infringe copyright of a warning. However, the present invention is not limited to such an example. For example, a program file that causes music data to be prohibited from being transmitted may be attached to such warning mail. The program file attached to the warning mail may be a micro program designed to be automatically executed in a predetermined environment. Thus, music data that may infringe copyright can be prevented from being transmitted in advance.

The above-described program that causes music data to be prohibited from being transmitted and that is sent to the user is not limited to such a micro program. Alternatively, the program may be a program that operates for browser software that is used to access the network 1 on the information device 11. Alternatively, the program may operate for OS (Operating System) on the information device 11. Alternatively, the program may operate for a protocol used for a communication between the information device 11 and the network 1.

In this case, it is more preferred to provide the user with a means for canceling the state of which music data is prohibited from being transmitted. For example, when music data is prohibited from being transmitted, by performing a predetermined copyright licensing process for the music data against the copyright owner, the user can obtain the canceling means. When the user uses the canceling means for the information device 11, the transmission of the music data can be permitted.

There will be several manners for providing the user with the canceling means. When the present invention is applied for the Internet, a web page that allows the state of which music data is prohibited from being transmitted to be cancelled is prepared on the Internet. The prohibition cancellation homepage is accessed by a user who has received the above-described warning. It is more preferred to cause the information device 11 to automatically access the prohibition cancellation homepage when he or she receives the warning.

The prohibition cancellation homepage prompts the user who has accessed it to perform user registration. In addition, the prohibition cancellation homepage causes a program for canceling the music data prohibition state to be sent to the information device 11. When the user has performed the user registration, it is assumed that he or she has performed the copyright licensing process as a registered user. As a result, the user is registered to the user database 105. Thus, the user is permitted to transmit the music data. When the prohibition cancellation program is executed, the music data for which the user has performed the copyright licensing process can be transmitted from the information device 11.

The effective range of the transmission prohibition of music data by the prohibiting means and the canceling means is not limited to music data. For example, the effective range may be applied for other copyrighted data that belong to the copyright owner of the music data.

In addition, as with the first embodiment, a program that causes music data (communication data) that is transmitted to be destroyed can be transmitted to the user. For example, the program is designed so that after music data is destroyed, it is transmitted.

When the present invention is applied for the Internet, it is more preferred to dispose the function of the gateway 20 according to the first embodiment and the function of the server 10 according to the second embodiment to each gateway or each server on the Internet.

The above example describes that the present invention is applied for music data. However, the present invention is not limited to such an example. In addition, the present invention can be applied for other copyrighted work data that can be distributed on the network (for example, still picture data, moving picture data, and game software).

In addition, when the server 10 and the gateway 20 according to the present invention are disposed on the Internet as a network, a predetermined benefit can be obtained from a copyright owner of music data corresponding to the number of users registered to the user database 105. In other words, the larger the number of users registered to the user database 105, the more the copyright licensing process is performed. In addition, music data can be prevented from being illegally distributed on the network.

Thus, a copyright owner of music data can obtain a royalty corresponding to the number of users registered to the user database 105. In addition, the loss of the benefit due to an illegal distribution of music data on the network can be decreased. Thus, part of the royalty of music data can be returned from the copyright owner to the side that disposes the server 10 and the gateway 20.

As was described above, according to the first embodiment of the present invention, when copyrighted work data whose copyright licensing process has not been performed is detected from communication data, since the communication data is prohibited from being transmitted to the server, the copyrighted work can be prevented from being infringed on the network.

In addition, according to the second embodiment of the present invention, when copyrighted work data whose copyright licensing process has not been performed is detected from communication data, the transmission source of the communication data is notified of a warning. In addition, the transmission source is requested to perform the predetermined copyright licensing process. Thus, the copyright licensing process for the copyrighted work is promoted. In addition, the copyright of the copyrighted work on the network can be prevented from being infringed.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention.

What is claimed is:

1. A copyrighted work managing method for managing copyrighted work data transmitted on a communication network, comprising the steps of:
(a) detecting copyrighted work data from communication data transmitted from a client on the communication network;
(b) determining whether or not a user of the client has performed a copyright licensing process for the copyrighted work data detected at the detecting step (a) against a copyright owner of the copyrighted work data; and
(c) prohibiting the communication data from being transmitted corresponding to the determined result at the determining step (b).

2. The copyrighted work managing method as set forth in claim 1,
wherein when the determined result at the determining step (b) represents that the user has not performed the copyright licensing process for the copyrighted work data, the copyright owner is notified that the user has not performed the copyright licensing process for the copyrighted work data.

3. The copyrighted work managing method as set forth in claim 1,
wherein when the determined result at the determining step (b) represents that the user has not performed the copyright licensing process for the copyrighted work data, the user is notified that he or she is prompted for performing the copyright licensing process for the copyrighted work data.

4. The copyrighted work managing method as set forth in claim 1,
wherein when the determined result at the determining step (b) represents that the user has not performed the copyright licensing process for the copyrighted work data, program data for causing the copyrighted work data to be prohibited from being transmitted is transmitted to the client.

5. A copyrighted work managing apparatus for managing copyrighted work data transmitted on a communication network, comprising:
detecting means for detecting copyrighted work data from communication data transmitted from a client on the communication network;
determining means for determining whether or not a user of the client has performed a copyright licensing process for the copyrighted work data detected by said detecting means against a copyright owner of the copyrighted work data; and
transmission prohibiting means for prohibiting the communication data from being transmitted corresponding to the determined result of said determining means.

6. A copyrighted work managing method for managing copyrighted work data transmitted on a communication network, comprising the steps of:
(a) detecting copyrighted work data from communication data transmitted from a client on the communication network;
(b) determining whether or not a user of the client has performed a copyright licensing process for the copyrighted work data detected at the detecting step (a) against a copyright owner of the copyrighted work data; and
(c) notifying the user that he or she has not performed the copyright licensing process corresponding to the determined result at the determining step (b).

7. The copyrighted work managing method as set forth in claim 6,
wherein when the determined result at the determining step (b) represents that the user has not performed the copyright licensing process for the copyrighted work data, the copyright owner is notified that the user has not performed the copyright licensing process for the copyrighted work data.

8. The copyrighted work managing method as set forth in claim 6,
wherein when the determined result at the determining step (b) represents that the user has not performed the copyright licensing process for the copyrighted work data, the communication data is prohibited from being transmitted.

9. The copyrighted work managing method as set forth in claim 8,
wherein program data for prohibiting the copyrighted work data from being transmitted is transmitted to the client so as to prohibit the communication data from being transmitted.

10. The copyrighted work managing method as set forth in claim 6,
wherein when the determined result at the determining step (b) represents that the user has not performed the copyright licensing process for the copyrighted work data, the communication data for transmitting the copyrighted work data is destroyed.

11. The copyrighted work managing method as set forth in claim 10,
wherein program data for causing the communication data for transmitting the copyrighted work data to be destroyed is transmitted to the client so as to destroy the communication data.

12. A copyrighted work managing apparatus for managing copyrighted work data transmitted on a communication network, comprising:
detecting means for detecting copyrighted work data from communication data transmitted from a client on the communication network;
determining means for determining whether or not the user has performed a copyright licensing process for the copyrighted work data detected by said detecting means against a copyright owner of the copyrighted work data; and
notifying means for notifying the user that he or she has not performed the copyright licensing process corresponding to the determined result of said determining means.

13. A copyrighted work managing method for managing copyrighted work data transmitted on a communication network, comprising the steps of:
(a) detecting copyrighted work data from communication data transmitted from a client on the communication network;
(b) determining whether or not the user has performed a copyright licensing process for the copyrighted work data detected at the detecting step (a) against a copyright owner of the copyrighted work data; and
(c) destroying the communication data corresponding to the determined result at the determining step (b).

14. The copyrighted work managing method as set forth in claim 13,
wherein when the determined result at the determining step (b) represents that the user has not performed the copyright licensing process for the copyrighted work data, the copyright owner is notified that the user has not performed the copyright licensing process for the copyrighted work data.

15. The copyrighted work managing method as set forth in claim 13,
wherein when the determined result at the determining step (b) represents that the user has not performed the copyright licensing process for the copyrighted work data, the user is notified that he or she is prompted for performing the copyright licensing process for the copyrighted work data.

16. The copyrighted work managing method as set forth in claim 13,
wherein when the determined result at the determining step (b) represents that the user has not performed the copyright licensing process for the copyrighted work data, program data for causing the communication data for transmitting the copyrighted work data to be destroyed is transmitted to the client.

17. A copyrighted work managing apparatus for managing copyrighted work data transmitted on a communication network, comprising:
detecting means for detecting copyrighted work data from communication data transmitted from a client on the communication network;
determining means for determining whether or not the user has performed a copyright licensing process for the copyrighted work data detected by said detecting means against a copyright owner of the copyrighted work data; and
destroying means for destroying the communication data corresponding to the determined result of said determining means.
